(19) United States
(12) Patent Application Publication
(10) Pub. No.: US 2006/0125762 A1
(43) Pub. Date: Jun. 15, 2006

(54) Electro-optical device and electronic apparatus

(75) Inventor: Shin Fujita, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/299,334

(22) Filed: Dec. 9, 2005

(30) Foreign Application Priority Data
Dec. 10, 2004 (JP) 2004-357712

(51) Int. Cl. G09G 3/36

(52) U.S. Cl. 345/98

(57) ABSTRACT

An electro-optical device includes a plurality of first electrodes that are disposed to correspond to intersections of a plurality of scanning lines and a plurality of data lines, a second electrode that is provided to face the first electrodes, an electro-optical material that is interposed between the first electrodes and the second electrode, and switching elements that control the potential of each of the first electrodes. The potential of the second electrode alternately changes, and a positive-polarity video signal and a negative-polarity video signal are alternately written into the individual first electrodes for each predetermined period via the electro-optical material. For the plurality of data lines, each of which supplies a video signal to each first electrode, a writing auxiliary circuit is partially provided so as to discharge electric charges accumulated in the data lines.

The entire disclosure of Japanese Application No. 2004-357712, filed Dec. 10, 2004 is expressly incorporated by reference herein.

### BACKGROUND

1. Technical Field

The present invention relates to an electro-optical device, such as a liquid crystal device or the like, and to an electronic apparatus.

2. Related Art

As an electro-optical device according to the related art, an active matrix-type liquid crystal device having a liquid crystal display panel in which pixels are arranged in a matrix shape and a thin film transistor is provided for each pixel is known. In recent years, in such a liquid crystal device, screen size and pixel density have increased, and a time assigned to write a video signal into each pixel has decreased. Further, under the present situation in which the use of the liquid crystal device for a mobile apparatus is widespread, it is very important to achieve low power consumption of the liquid crystal device.

As a measure for easy writing of the video signal, a technology is known in which, prior to writing of the video signal, data lines are charged in advance by use of switching elements (for example, see Japanese Patent No. 2,830,004). A liquid crystal display device according to the related art includes a unit that inverts the polarity of an image signal for each predetermined period, and a unit that precharges the potential of a first signal line to a certain intermediate potential of the image signal from a separate line from a line for supplying the image signal to the first signal line (data line).

Further, a liquid crystal device is known in which, as one method for realizing low power consumption, a common swing driving system is performed (for example, see JP-A-8-334741). In such a liquid crystal device, the potential of a common electrode (counter electrode) facing a pixel electrode of each pixel with liquid crystal interposed therebetween is inverted for each field.

In such a common swing driving system, the video signal has constant black and white levels, and the potential of the counter electrode swings for each predetermined period. Then, a positive-polarity video signal and a negative-polarity video signal are alternately written into each pixel for each predetermined period, such that alternating current (AC) driving of liquid crystal is performed. Accordingly, the output level of the video signal can be suppressed at a low level, a driving IC having low withstand voltage can be used, and capacity of an output amplifier can be made low. As a result, low power consumption can be realized.

However, in the liquid crystal device of the common swing driving system, like the related art described in JP-A-8-334741, an electric charge of the video signal is written into a capacitor of each pixel, and the potential of the counter electrode is inverted in a state in which the electric charge is held. Moreover, the term ‘invert’ means that a positive potential is switched to a negative potential (or the negative potential is switched into the positive potential) with a predetermined potential (for example, 0 (zero)) as a reference.

For example, when the potential (common potential) of the common electrode is inverted between a low potential and a high potential for each horizontal scanning period, in a horizontal scanning period, the positive-polarity video signal is written into each of the pixels corresponding to one selected scanning line in a state in which the common potential VCOM is the low potential.

Prior to the next horizontal scanning period after the writing operation ends, if the common potential VCOM is inverted to the high potential in a state in which the electric charge written into the pixel electrode of each pixel is held, the potential of each pixel electrode is affected and rises due to capacitive coupling to a common line, and a positive-polarity potential difference occurs between the common line and each pixel electrode. At this time, the potential of each data line also rises due to capacitive coupling to the common line, together with the potential of each pixel electrode. On the other hand, in a horizontal scanning period, after the negative-polarity video signal is written into each pixel, if the common potential is inverted from the high potential to the low potential, the potential of each pixel electrode is affected and falls due to capacitive coupling to the common line, and a negative-polarity potential difference occurs between the common line and each pixel electrode. At this time, the potential of each data line also falls due to capacitive coupling to the common line, together with the potential of each pixel electrode.

As such, when the potential of each data line changes due to the common swing driving system, the level of a voltage to be written into each pixel is made higher than the level of a voltage according to a gray-scale value of the video signal of each pixel by the amount of the change. Accordingly, a deficiency in writing of the video signal into each pixel easily occurs. The problem of such a deficiency in writing drastically occurs in a liquid crystal device having a large screen and high pixel density in which the time assigned to write the video signal into each pixel is decreased.

### SUMMARY

An advantage of some aspects of the invention is that it provides an electro-optical device which achieves easy writing of a video signal into each pixel, and an electronic apparatus.

According to an aspect of the invention, an electro-optical device includes a plurality of first electrodes that are disposed to correspond to intersections of a plurality of scanning lines and a plurality of data lines, a second electrode that is provided to face the first electrodes, an electro-optical material that is interposed between the first electrodes and the second electrode, and switching elements that control the potential of each of the first electrodes. The potential of the second electrode alternately changes, and a positive-polarity video signal and a negative-polarity video signal are alternately written into the individual first electrodes for each predetermined period via the electro-optical material. Further, for the plurality of data lines, each of which supplies a video signal to each first electrode, a writing auxiliary circuit is partially provided so as to discharge electric charges accumulated in the data lines.

Here, the ‘predetermined period’ is, for example, one horizontal scanning period, one frame period, or the like.

According to this configuration, if the potential of each data line changes due to a so-called common swing driving system in which the potential of the second electrode alternately changes for each predetermined period, the electric charge accumulated in each data line is discharged by the writing auxiliary circuit, and thus the potential of each data line returns to the potential before the change. For example, after the positive-polarity video signal is written into each first electrode in a predetermined period, if the potential of the second electrode is inverted from a low potential to a high potential, the potential of each first electrode is affected and rises due to capacitive coupling to a common line, and a positive-polarity potential difference occurs between the common line and each first electrode. At this time, the potential of each data line also rises due to capacitive coupling to the common line, together with the potential of each first electrode. On the other hand, after the negative-polarity video signal is written into each first electrode in a predetermined period, if the potential of the second electrode is inverted from the high potential to the low potential, the potential of each first electrode is affected and falls due to capacitive coupling to the common line, and a negative-polarity potential difference occurs between the common line and each first electrode. At this time, the potential of each data line also falls due to capacitive coupling to the common line, together with the potential of each first electrode.

As such, when the potential of each data line changes due to the common swing driving system, the potential of each data line returns to the potential before the change by the writing auxiliary circuit, and thus the potential of the change amount does not need to be written into each first electrode. For this reason, the level of a voltage to be written into each first electrode becomes the level of a voltage according to a gray-scale value of the video signal of each pixel, and thus the video signal can be easily written into each pixel in the next predetermined period. That is, writing of a normal video signal into each pixel (each first electrode) is helped. In particular, even when a large screen and a high density are advanced, writing of the video signal into each pixel can be facilitated, and thus an electro-optical device which can perform high-definition display can be implemented. Moreover, here, ‘writing of the normal video signal’ means that, when the video signal of each pixel is image data represented by an n-bit gray-scale value, the gray-scale value of the video signal of each pixel is converted into an analog signal, and a video signal having a voltage value of the converted analog signal is written into each pixel.

In the electro-optical device according to the aspect of the invention, it is preferable that the writing auxiliary circuit be a discharging circuit that has either reverse diodes or forward diodes.

According to this configuration, when the potential of each data line changes due to the common swing driving system, the potential of each data line is rapidly discharged through one of the reverse diode and the forward diode up to a predetermined potential, and thus the potential of each data line returns to the potential before the change. Therefore, the video signal can be easily written into each pixel in the next predetermined period.

In the electro-optical device according to the aspect of the invention, it is preferable that the writing auxiliary circuit be a discharging circuit that has both reverse diodes and forward diodes.

According to this configuration, when the potential of each data line is affected and rises due to the common swing driving system, a current rapidly flows through the forward diode from each data line, and thus the potential of each data line falls up to the potential before the change. On the other hand, when the potential of each data line is affected and falls due to the common swing driving system, a current rapidly flows through the reverse diode to each data line, and thus the potential of each data line rises up to the potential before the change. Accordingly, even when the potential of each data line is affected and rises or is affected and falls due to the common swing driving system, the potential of each data line can return to the potential before the change, such that the video signal can be easily written into each pixel in the next predetermined period.

In the electro-optical device according to the aspect of the invention, it is preferable that the reverse diodes and the forward diodes are MOS diodes.

According to this configuration, if the reverse diodes and the forward diodes used for the discharging circuit are the MOS diodes, a circuit configuration can be implemented, without adding a new manufacturing process.

In the electro-optical device according to the aspect of the invention, it is preferable that the reverse diodes and the forward diodes are PIN diodes.

Moreover, the ‘PIN diode’ described herein is the general term of a diode in which an I layer (intrinsic semiconductor layer) is inserted between a P-type semiconductor and an N-type semiconductor, and a PIN junction is performed.

According to this configuration, the PIN diode does not require a gate electrode, unlike the MOS diode. Therefore, even when the diode is broken due to static electricity to be applied at the time of handling during the manufacture or after the manufacture, there is no case in which gate leakage occurs, unlike the MOS diode.

In the electro-optical device according to the aspect of the invention, it is preferable that the reverse diodes and the forward diodes are MOS diodes, each of which uses a four-terminal thin film transistor.

According to this configuration, if the reverse diodes and the forward diodes used for the discharging circuit are the MOS diodes, each of which uses the four-terminal thin film transistor (TFT), the following effects are obtained. In general, the MOS diode becomes an ON state when a gate voltage Vg exceeds a threshold voltage Vth. Accordingly, when Vg is 0 (zero), the MOS diode is not regarded as the ON state, and, when the gate voltage Vth equal to or higher than Vth is applied, the MOS diode becomes the ON state. In contrast, in case of the MOS diode using the four-terminal thin film transistor, the threshold voltage Vth can be controlled by controlling a back gate voltage thereof, and thus the MOS diode using the four-terminal thin film transistor is turned on by the gate voltage Vg lower than that of a general MOS diode. Therefore, writing of the video signal into each pixel can be further facilitated.

In the electro-optical device according to the aspect of the invention, it is preferable that a power supply connected to the reverse diode is a low-potential voltage of a power supply voltage.

Moreover, the ‘low-potential voltage of power supply voltage’ is, for example, VSS (GND).

According to this configuration, when the potential of each data line is affected and falls due to the common swing driving system, the potential of each data line can rapidly rise up to the low-potential voltage of the power supply voltage. Further, if the power supply connected to the reverse diode is the low-potential voltage of the power supply voltage, writing of the video signal can be helped, without adding a new power supply.

In the electro-optical device according to the aspect of the invention, it is preferable that a power supply connected to the forward diode have a level equal to or higher than a high-potential voltage value of a swing level of the video signal, and a power supply connected to the reverse diode have a level equal to or lower than a low-potential voltage value of the swing level of the video signal.

According to this configuration, even when the potential of each data line becomes high or low at a point of time at which the video signal is written in the next predetermined period, the potential of each data line can be made substantially equal to the level of the video signal, a deficiency in writing of the video signal into each pixel can be suppressed from occurring. Therefore, writing of the video signal into each pixel can be further helped by supplying a separate power supply, such as the power supply that has the level equal to or higher than the value of the high-potential voltage VideoH of the swing level of the video signal or the power supply that has the level equal to or lower than the value of the low-potential voltage VideoL of the swing level.

According to this configuration, when the potential of each data line is affected and falls due to the common swing driving system, the potential of each data line can rapidly rise up to the low-potential voltage of the power supply voltage. Further, if the low-potential voltage connected to the reverse diode is, for example, VSS (GND), writing of the video signal can be helped, without adding a new power supply.

According to another aspect of the invention, an electronic apparatus includes the above-described electro-optical device.

According to this configuration, even when the large screen and the high density are advanced, writing of the video signal into each pixel can be facilitated, and thus an electronic apparatus which can perform high-definition display can be implemented.

### BRIEF DESCRIPTION OF THE DRAWINGS

The invention will be described with reference to the accompanying drawings, wherein like numbers reference like elements.

FIG. 1 is a plan view showing a liquid crystal device according to a first embodiment of the invention.

FIG. 2 is a cross-sectional view showing an internal structure of a liquid crystal display panel of the liquid crystal device.

FIG. 3 is a diagram schematically showing an electrical configuration of the liquid crystal device.

FIG. 4 is a diagram schematically showing an electrical configuration of essential parts of a driving circuit of the liquid crystal device.

FIG. 5A is a circuit diagram showing the connection of a data line and a reverse diode in the liquid crystal device.

FIG. 5B is an equivalent circuit diagram of the reverse diode.

FIG. 6 is a timing chart showing an operation of the liquid crystal device according to the first embodiment of the invention.

FIG. 7 is a plan view of a PIN diode which is used in a liquid crystal device according to a second embodiment of the invention.

FIG. 8 is a plan view of a four-terminal diode which is used in a liquid crystal device according to a third embodiment of the invention.

FIG. 9 is a circuit diagram showing a configuration in which both a reverse diode and a forward diode are connected to a data line, in a liquid crystal device according to a fourth embodiment of the invention.

FIG. 10A is a timing chart showing an operation of the liquid crystal device.

FIG. 10B is a timing chart showing an operation of the liquid crystal device.

FIG. 11 is a perspective view showing an example of an electronic apparatus.

FIG. 12A is a timing chart showing an operation of a liquid crystal device according to the related art, in which a common swing driving system is performed.

FIG. 12B is a timing chart showing an operation of a liquid crystal device according to the related art, in which a common swing driving system is performed.

### DESCRIPTION OF EXEMPLARY EMBODIMENTS

Hereinafter, embodiments, which specify the invention, will be described with reference to the drawings.

### First Embodiment

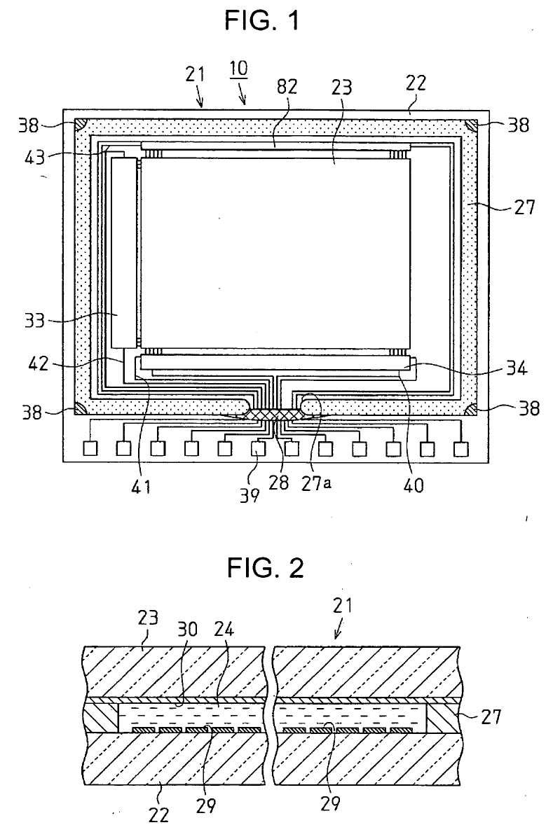

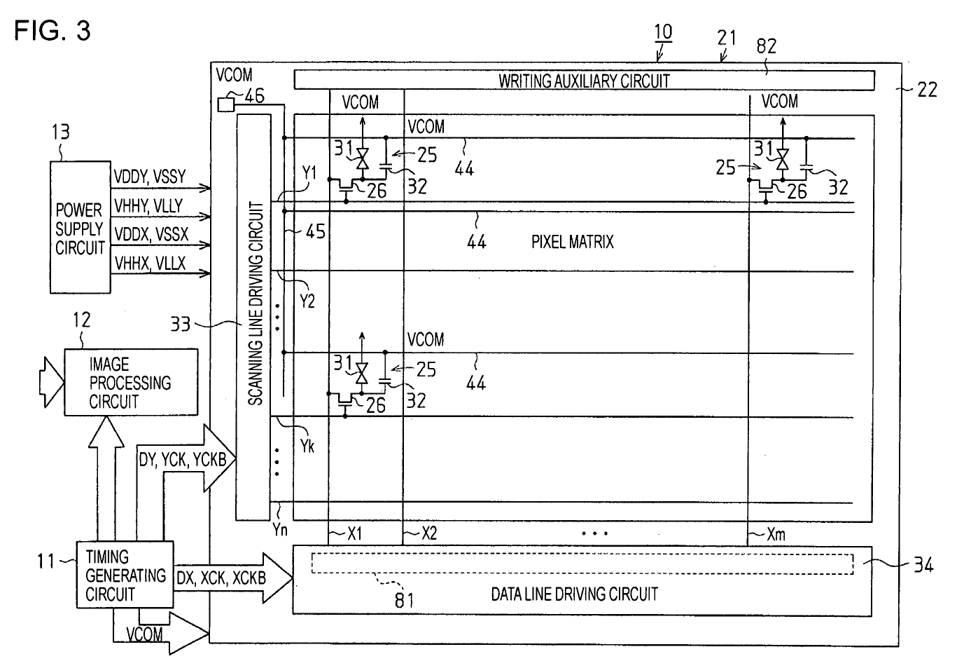

FIG. 1 shows a liquid crystal display panel, excluding an external circuit, of a liquid crystal device according to a first embodiment of the invention. FIG. 2 is a cross-sectional view of the liquid crystal display panel which is partially cut. FIG. 3 schematically shows the electrical configuration of a liquid crystal device, which serves as an electro-optical device.

A liquid crystal device 10 of the present embodiment is an active matrix-type liquid crystal device in which peripheral driving circuits are incorporated by use of polycrystalline silicon thin film transistors. Further, the liquid crystal device 10 is constituted to perform a common swing driving system in which the potential (common potential VCOM) of a counter electrode serving as a second electrode which faces a pixel electrode (first electrode) of each pixel is inverted between a low potential and a high potential for each horizontal scanning period, which serves as a predetermined period. Further, in the liquid crystal device 10, a positive-polarity video signal and a negative-polarity video signal are alternately written into each pixel.

The liquid crystal device 10 has a liquid crystal display panel 21. As shown in FIGS. 1 and 2, the liquid crystal display panel 21 has an element substrate 22 and a counter substrate 23, and, for example, twisted nematic (TN) liquid crystal 24 is filled between the two substrates. The element substrate 22 and the counter substrate 23 are bonded to each other at a constant gap with a sealant 27 including spacers (not shown) such that electrode formation surfaces thereof face each other, and liquid crystal 24 is filled between the substrates. The sealant 27 is formed along an outer edge of the counter substrate 23, and has an opening 27a for filling liquid crystal 24. The opening 27a is sealed by a sealing material 28 after liquid crystal 24 is filled.

As shown in FIGS. 2 and 3, in the element substrate 22, a plurality of scanning lines Y1 to Yn arranged in a Y direction, a plurality of data lines X1 to Xm arranged in an X direction, and a plurality of pixels 25 disposed in a matrix shape to correspond to intersections of the scanning lines Y1 to Yn and the data lines X1 to Xm are formed. Further, in the element substrate 22, for each pixel 25, a polycrystalline silicon thin film transistor (hereinafter, referred to as ‘TFT) 26 serving as a switching element is formed. A gate of the TFT 26 is connected to one of the scanning lines Y1 to Yn, a source thereof is connected to one of the data lines X1 to Xm, and a drain thereof is connected to a pixel electrode 29 of a corresponding pixel 25. A video signal is written into each pixel 25 through the TFT 26. The plurality of scanning lines Y1 to Yn, the plurality of data lines X1 to Xm, and the plurality of pixels 25 constitute a pixel matrix as a display region (see FIG. 3). Further, in the element substrate 22, silver points 38 that serve as connection terminals to the counter substrate 23, input terminals 39 to which various signals are inputted from an external circuit, a X driver signal line 40, a video signal line 41, a Y driver signal line 42, a power supply line 43, and the like are formed. The power supply line 43 is a wiring line for supplying a predetermined power supply voltage to a writing auxiliary circuit 82, which is described below.

As shown in FIGS. 2 to 4, the pixel electrode 29 of each pixel 25 faces one common electrode 30, which serves as a counter electrode provided in the counter substrate 23, with liquid crystal 24 interposed therebetween. Further, each pixel 25 has a liquid crystal capacitor 31 that is constituted by the pixel electrode 29 having a rectangular shape, the common electrode 30, and liquid crystal 24 between the pixel electrode 29 and the common electrode 30, and a storage capacitor 32 that is connected in parallel with the liquid crystal capacitor 31 so as to reduce leakage of liquid crystal capacitance. By doing so, a pixel circuit of each pixel 25 is constituted by the TFT 26, the pixel electrode 29, the common electrode 31, the storage capacitor 32, and the like. Then, in the pixel circuit of each pixel 25, if the TFT 26 is turned on (conductive state), the video signal of each pixel converted into a voltage signal is written into the liquid crystal capacitor 31 and the storage capacitor 32 through the TFT 26. Further, if the TFT 26 is turned off (non-conductive state), an electric charge is held in the capacitors.

As shown in FIGS. 1 and 3, the liquid crystal device 10 has a scanning line driving circuit (Y driver) 33 for driving the scanning lines Y1 to Yn and a data line driving circuit (X driver) 34 for driving the data lines X1 to Xm, as the above-described peripheral driving circuits formed on the element substrate 22. These driving circuits are formed on the element substrate 22 by use of a thin film transistor formation technology. Further, the liquid crystal device 10 has a timing generating circuit 11, an image processing circuit 12, and a power supply circuit 13, as shown in FIG. 3, as the external circuits.

The timing generating circuit 11 supplies synchronization signals and clock signals to the scanning line driving circuit 33 and the data line driving circuit 34 and controls operation timings of these driving circuits. From the timing generating circuit 11 to the scanning line driving circuit 33, a transmission start signal DY serving as the synchronization signal, a clock signal YCK, and an inverted clock signal YCKB are supplied. From the timing generating circuit 11 to the data line driving circuit 34, a transmission start signal DX serving as the synchronization signal, a clock signal XCK, and an inverted clock signal XCKB are supplied. Further, the timing generating circuit 11 controls an operation timing of the image processing circuit 12 in synchronization with the synchronization signals and the clock signals described above. Then, in order to perform the above-described common swing driving system in synchronization with the synchronization signals and the clock signals described above, the timing generating circuit 11 switches a voltage to be supplied to a VCOM terminal 46 (common voltage VCOM) between a low potential and a high potential for each horizontal scanning period.

The image processing circuit 12 processes an input video signal, such as a video signal, a television signal, or the like, and supplies the processed video signal to the data line driving circuit 34 with an operation timing to be controlled by the timing generating circuit 11. In the present embodiment, the video signal to be supplied from the image processing circuit 12 to the data line driving circuit 34 includes image data of each pixel. Image data of each pixel is digital gray-scale data representing brightness of each pixel, for example, in an 8-bit binary number, and has 256 gray-scale values of 0 to 255.

The power supply circuit 13 generates and outputs various power supply voltages shown in FIG. 3.

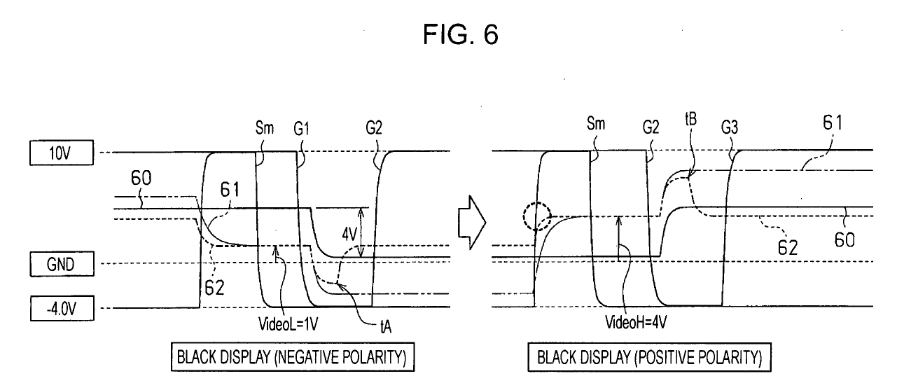

The scanning line driving circuit 33 sequentially generates and outputs scanning signals G1 to Gn (see FIG. 6) on the basis of the transmission start signal DY, the clock signal YCK, and the inverted clock signal YCKB, which are supplied at the beginning of a vertical scanning period (at the beginning of one frame), such that the scanning lines Y1 to Yn are sequentially selected. If the scanning lines Y1 to Yn are sequentially selected and the scanning signals G1 to Gn are supplied to the individual scanning lines, all the TFTs 26 connected to the selected scanning line are turned on. Moreover, in the present specification, ‘one horizontal scanning period’ means a period in which the video signals are written into the capacitors of all the pixels 25 connected to one of the scanning lines Y1 to Yn to be sequentially selected, and display for one line is performed.

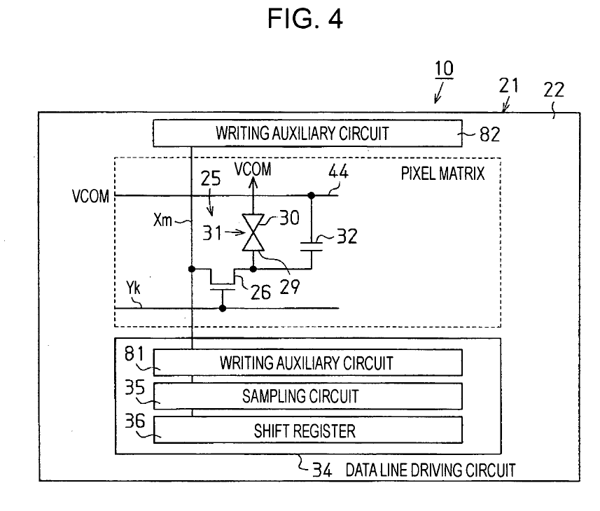

As shown in FIG. 4, the data line driving circuit 34 has a shift register 36, a sampling circuit 35, a digital/analog converter (not shown), and the like.

The shift register 36 sequentially generates and outputs selection signals S1 to Sm (see FIG. 6) on the basis of the transmission start signal DX, the clock signal XCK, and the inverted clock signal XCKB, which are supplied at the beginning of each horizontal scanning period. In the present embodiment, each of the selection signals S1 to Sm is a pulse signal of the H level.

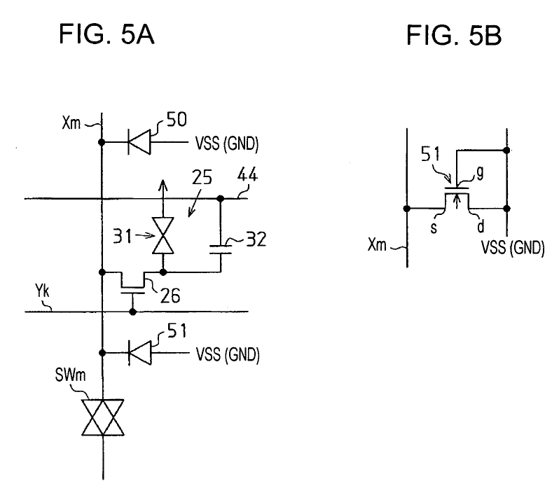

The sampling circuit 35 has a plurality of switches SW1 to SWm (see FIG. 5), which are provided to correspond to the data lines X1 to Xm. Moreover, FIG. 5 shows the switch SWm, which is provided in the m-the column data line Xm, and other switches SW1 to SWm-1 provided to correspond to the data lines X1 to Xm-1 are omitted. Each of the switches SW1 to SWm is constituted by a transmission gate that opens when a corresponding one of the selection signal S1 to Sm of the H level is input thereto. In the present embodiment, the transmission gate constituting each of the switches SW1 to SWm may be a single channel-type transmission gate, which has two N-channel TFTs or two P-channel TFTs. Further, the transmission gate constituting each of the switches SW1 to SWm may be constituted by a complementary transmission gate, which has a P-channel TFT and an N-channel TFT and which opens when a signal of the L level is input to a gate thereof.

In the data line driving circuit 34 having such a configuration, in each horizontal scanning period, if the selection signals S1 to Sm of the H level are input to the switches SW1 to SWm provided to correspond to the data lines X1 to Xm sequentially from the first column data line X1, the switches SW1 to SWm sequentially open. Accordingly, the video signals are written into the individual pixels through the individual data lines X1 to Xm and the TFTs 26 of the individual pixels 25.

Then, as shown in FIGS. 1, 3, and 4, the liquid crystal device 10 has a feature in that writing auxiliary circuits 81 and 82 are provided on both an input terminal and an output terminal of each of the plurality of data lines X1 to Xm, which supply the video signals to the pixel electrodes 29 of the individual pixels 25. Each of the writing auxiliary circuits 81 and 82 is provided as an internal circuit of the data line driving circuit 34, and discharges the electric charge accumulated in each of the data lines X1 to Xm so as to return the potential of each of the data lines X1 to Xm changed due to the above-described common swing driving system to the potential before the change. Here, ‘the potential before the change’ is used to include a potential close to the potential before the change, as well as the same potential as the potential before the change. Further, in the following description, the potential of the common electrode (second electrode) 30 is referred to as ‘common potential’, which is the potential VCOM of the counter electrode facing the pixel electrode (first electrode) 29 of each pixel with liquid crystal 24 serving as an electro-optical material interposed therebetween.

As shown in FIG. 5A, the writing auxiliary circuit 81 is a discharging circuit that has reverse diodes 51 each connected to one of the input terminal and the output terminal of each of the data lines X1 to Xm. Further, the writing auxiliary circuit 82 is a discharging circuit that has reverse diodes 50 each connected to the other of the input terminal and the output terminal of each of the data lines X1 to Xm. All the reverse diodes 50 and 51 are MOS diodes. If the reverse diodes 50 and 51 are MOS diodes, the reverse diodes 50 and 51 are formed on the element substrate 22 by use of the thin film transistor formation technology, together with the above-described peripheral driving circuits. Further, a power supply connected to each of the reverse diodes 50 and 51 has a low-potential voltage. The low-potential voltage is VSS (GND). A source of each of the reverse diodes 50 and 51 is connected to the data line Xm, and a gate and a drain are brought into diode connection and are connected to the low-potential voltage VSS (GND) (see FIGS. 5A and 5B).

The discharging circuit of the writing auxiliary circuit 81 has the data lines X1 to Xm, reverse diodes 51 correspondingly connected to the data lines X1 to Xm, and the voltage VSS (GND) connected to the individual reverse diodes 51. The operation of the discharging circuit will be described with reference to an equivalent circuit diagram shown in FIG. 5B. FIG. 5B shows the reverse diode 51 connected to one of the plurality of data lines X1 to Xm (data line Xm). The reverse diode 51 is equivalent to an N-channel TFT in which a gate g and a drain d are brought into diode connection, and a source s is connected to the data line Xm. When the potential of the data line Xm falls due to the above-described common swing driving system and is made lower than the voltage VSS (GND), and a potential difference exceeding a threshold value Vth occurs between the gate and the source, the reverse diode 51 becomes the ON state, and a drain current flows from the drain d to the source s. With this drain current, when the potential of the data line Xm rises and is close to the voltage VSS (GND) (returns up to the potential before the change), the reverse diode 51 becomes the OFF state. Other reverse diodes 51 constituting the discharging circuit of the writing auxiliary circuit 81 are also operated in the same manner. The reverse diodes 50, which constitute the discharging circuit of the writing auxiliary circuit 82 and which are correspondingly connected to the data lines X1 to Xm, are also operated in the same manner as the above-described reverse diodes 51.

Next, the operation of the liquid crystal device 10 of the present embodiment will be described through the comparison with the related art liquid crystal device, which performs the common swing driving system, like the related art described in JP-A-8-334741.

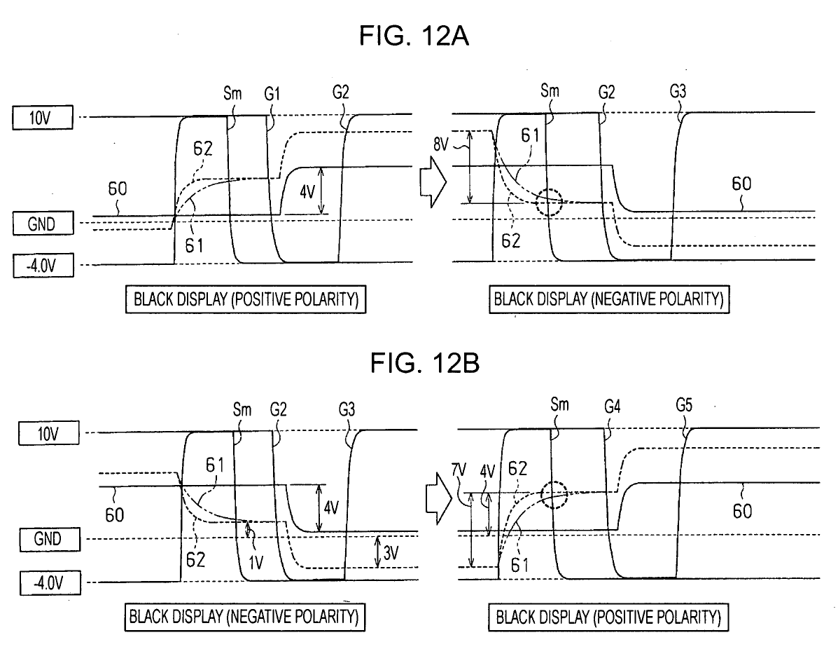

First, the operation of the related art liquid crystal device will be described with reference to FIGS. 12A and 12B. In FIGS. 12A and 12B, a solid line 60 denotes the change of the common potential VCOM, a two-dot-chain line 61 denotes the change of the pixel electrode of each pixel (change of pixel potential), and a dotted line 62 denotes the change of the potential of each data line (source potential).

Here, under the assumption that a normally-white-mode liquid crystal display panel is used, the description will be given. FIG. 12A shows a case in which, after a positive-polarity video signal (a data signal of black display) is written into the individual pixel corresponding to the selected one scanning line in a horizontal scanning period, a negative-polarity video signal is written into the next horizontal scanning period. FIG. 12B shows a case in which, after the negative-polarity video signal is written into the individual pixels, the positive-polarity video signal is written in the next horizontal scanning period, in contrast with the case of FIG. 12A.

As shown on the left side of FIG. 12A, in a first horizontal scanning period in which the scanning signal G1 of the H level is output, the positive-polarity video signal is written into the individual pixels in a state in which the common potential VCOM is the low potential. After the selection signal Sm for writing the video signal into the first row and the m-th column pixel becomes the L level, and the scanning signal G2 also becomes the L level, if the common potential VCOM is inverted to the low potential prior to the next horizontal scanning period, the pixel potential denoted by the two-dot-chain line 61 is affected and falls due to capacitive coupling to the common line, and a potential difference occurs between the common line and each pixel electrode. At this time, the potential of each pixel electrode and the potential of each data line also fall due to capacitive coupling to the common line.

Therefore, at the point of time at which the video signal is written in the next horizontal scanning period, a case in which the potential of each data line is lowest is as shown on the left side of FIG. 12B, like the right side of FIG. 12A. At this time, the potential of the data line is represented by (the low-potential level of the video signal)−(the swing level of the common potential VCOM). When the low-potential level of the video signal is 1 V, and the swing level of the common potential VCOM is 4 V, the potential of each data line becomes one lowest value of −3 V.

In this state, in a case in which the high-potential video signal (the positive-polarity video signal) is written, as shown on the right side of FIG. 12B, if the high-potential level of the video signal is 4 V, the potential difference of 7 V needs to be charged in each pixel. As such, when the potential of each data line falls up to −3 V due to the common swing driving system, the level of a voltage to be charged in each pixel by the change amount is made higher than the level of a voltage according to the gray-scale value of the video signal of each pixel, and thus a deficiency in writing of the video signal into each pixel may easily occur. That is, as apparent from a place indicated by a dotted-line circle on the right side of FIG. 12B, at the point of time at which the selection signal becomes the L level and writing of the video signal into the second row and the m-th column pixel ends, the potential of the pixel electrode of that pixel denoted by the two-dot-chain line 61 does not reach the high-potential level of the video signal, which causes the deficiency in writing of the video signal.

In contrast, in the liquid crystal device 10 according to the first embodiment, if the common potential VCOM is inverted to the low potential, as shown on the left side of FIG. 6, the potential of each of the data lines X1 to Xm falls, for example, up to −3 V, like the case shown on the left side of FIG. 12B. At this time, the individual reverse diodes 51 of the writing auxiliary circuit 81 and the individual reverse diodes 50 of the writing auxiliary circuit 82 become the ON state, and the drain current flows in the individual reverse diodes 50 and 51. Accordingly, if the potential of each of the data lines X1 to Xm rises from the point of time tA of FIG. 6 and is close to the voltage VSS (GND) (returns up to the potential before the change), the individual reverse diodes 50 and 51 become the OFF state. That is, the potential of each of the data lines. X1 to Xm which falls up to −3 V returns to the level close to VSS (GND). In this state, when the high-potential video signal is written, the level of a voltage to be written into each pixel 25 is made lower than 7 V in the related art liquid crystal device, and the deficiency in writing of the video signal into each pixel is difficult to occur.

The first embodiment having the above-described configuration has the following advantages.

When the potential of each of the data lines X1 to Xm falls (changes) due to the common swing driving system, the potential of each data line returns to the level close to the potential before the change due to the writing auxiliary circuits 81 and 82, such that a potential for the change amount does not need to be written into each pixel. For this reason, the level of the voltage to be written into each pixel becomes the level of the voltage according to the gray-scale value of the video signal of each pixel, and thus the video signal can be easily written into each pixel 25 in the next horizontal scanning period. That is, writing of the normal video signal into each pixel 25 can be helped.

Even when liquid crystal device 10 has a large screen and high pixel density, writing of the video signal into each pixel 25 is easily performed, such that the liquid crystal device 10 which can perform high-definition display can be implemented.

The writing auxiliary circuits 81 and 82 are constituted by the discharging circuits having the plurality of reverse diodes 51 and 50 correspondingly connected to the data lines X1 to Xm, respectively. Therefore, when the potential of each of data lines X1 to Xm falls due to the common swing driving system, the potential of each data line rapidly rises up to a predetermined potential by the discharge through each reverse diode. Accordingly, the potential of each data line returns to the level close to the potential before the change, and thus the video signal can be easily written into each pixel 25 in the next horizontal scanning period.

Since the reverse diodes 50 and 51 of the writing auxiliary circuits 81 and 82 are MOS diodes, the reverse diodes 50 and 51 are formed on the element substrate 22 by use of the above-described thin film transistor formation technology, together with the above-described peripheral driving circuits. Therefore, the writing auxiliary circuits 81 and 82 can be implemented, without adding a new manufacturing process.

### Second Embodiment

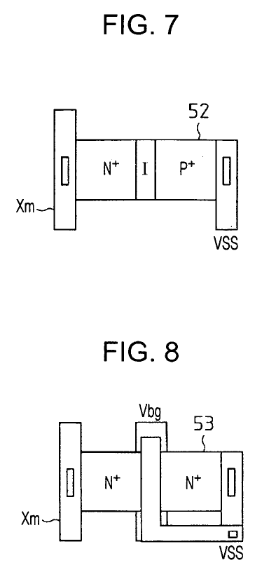

Next, a liquid crystal device 10 according to a second embodiment will be described with reference to FIG. 7. In the liquid crystal device 10, each of the reverse diodes 51 and 50 of the writing auxiliary circuits 81 and 82 is constituted by a PIN diode 52. Other parts are the same as those of the above-described first embodiment.

According to the second embodiment having such a configuration, the following advantage is obtained, in addition to the advantages of the above-described first embodiment.

The PIN diode 52 shown in FIG. 7 does not require a gate electrode, unlike the MOS diode. Therefore, even when the PIN diode 52 is broken due to static electricity to be applied at the time of handling during the manufacture or after the manufacture, there is no case in which gate leakage occurs, unlike the case in which each of the reverse diodes 51 and 50 is constituted by the MOS diode.

### Third Embodiment

Next, a liquid crystal device 10 according to a third embodiment will be described with reference to FIG. 8. In the liquid crystal device 10, each of the reverse diodes 51 and 50 of the writing auxiliary circuits 81 and 82 is constituted by a MOS diode 53 using a four-terminal thin film transistor shown in FIG. 8. Other parts are the same as those of the above-described first embodiment.

According to the third embodiment having such a configuration, the following advantage is obtained, in addition to the advantages of the above-described first embodiment.

Each of the reverse diodes 51 and 50 of the writing auxiliary circuits 81 and 82 is constituted by the MOS diode 53 using the four-terminal thin film transistor, and thus a threshold value Vth can be controlled by controlling a back gate voltage thereof. For this reason, the MOS diode is turned on with a gate voltage lower than that in a general MOS diode, such that writing of the video signal into each pixel 25 can be further facilitated.

### Fourth Embodiment

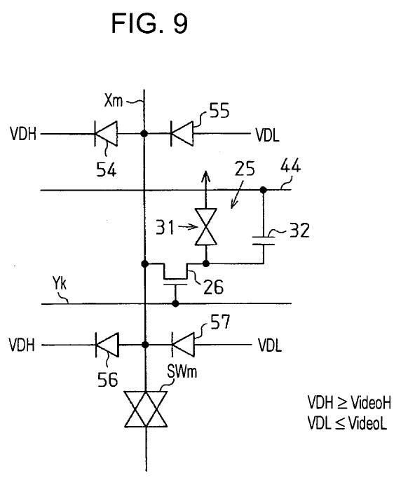

Next, a liquid crystal device 10 according to a fourth embodiment will be described with reference to FIG. 9. In the liquid crystal device 10, a writing auxiliary circuit 81 is a discharging circuit, which has both reverse diodes 57 and forward diodes 56. Further, a writing auxiliary circuit 82 is a discharging circuit, which has both reverse diodes 55 and forward diodes 54.

That is, in the writing auxiliary circuit 81, the reverse diode 57 and the forward diode 56 are connected to each of the data lines X1 to Xm. Further, in the writing auxiliary circuit 82, the reverse diode 55 and the forward diode 54 are connected to each of the data lines X1 to Xm. Each of the reverse diodes 55 and 57 is the MOS diode, like the reverse diodes 50 and 51 of the above-described first embodiment. Further, each of the forward diode 54 and 56 is the MOS diode, like the above-described reverse diodes 50 and 51.

That is, a power supply VDH, which is connected to each of the forward diodes 54 and 56, has a level equal to or higher than the high-potential voltage value VideoH of the swing level of the video signal. Further, a power supply VDL, which is connected to each of the reverse diodes 55 and 57, has a level equal to or lower than the low-potential voltage value VideoL of the swing level of the video signal. Other parts are the same as those in the above-described first embodiment.

Next, the operation of the liquid crystal device 10 according to the present embodiment will be described through the comparison with the operation of the related art liquid crystal device described above.

In the related art liquid crystal device described above, as described with reference to FIGS. 12A and 12B, at the point of time at which the video signal is written in the next horizontal scanning period, the case in which the potential of each data line is lowest is as shown on the left side of FIG. 12B. In this state, when the high-potential video signal (the positive-polarity video signal) is written, the level of the voltage to be written into each pixel is made higher than the level of the voltage according to the gray-scale value of the video signal of each pixel by the falling amount (the change amount) of the potential of each data line, for example, up to −3 V, due to the common swing driving system, such that the deficiency in writing of the video signal into each pixel may easily occur.

On the other hand, at the point of time at which the video signal is written in the next horizontal scanning period, a case in which the potential of each data line is highest is as shown on the left side of FIG. 12A. At this time, the potential of the data line is represented by (the high-potential level of the video signal)+(the swing level of the common potential VCOM). When the high-potential level of the video signal is 4 V, and the swing level of the common potential VCOM is 4 V, the potential of each data line to be highest becomes 8 V.

In this state, when the low-potential video signal (the negative-polarity video signal) is written, the level of the voltage to be written into each pixel is made higher than the level of the voltage according to the gray-scale value of the video signal of each pixel by the rising amount (the change amount) of the potential of each data line, for example, up to 8 V, due to the common swing driving system, such that the deficiency in writing of the video signal into each pixel may easily occur. That is, as apparent from a place indicated by a dotted-line circle on the right side of FIG. 12A, at the point of time at which the selection signal Sm becomes the L level and then writing of the video signal into the second row and m-th column pixel ends, the potential of the pixel electrode of that pixel denoted by the two-dot-chain line 61 does not reach the low-potential level of the video signal, which causes the deficiency in writing of the video signal.

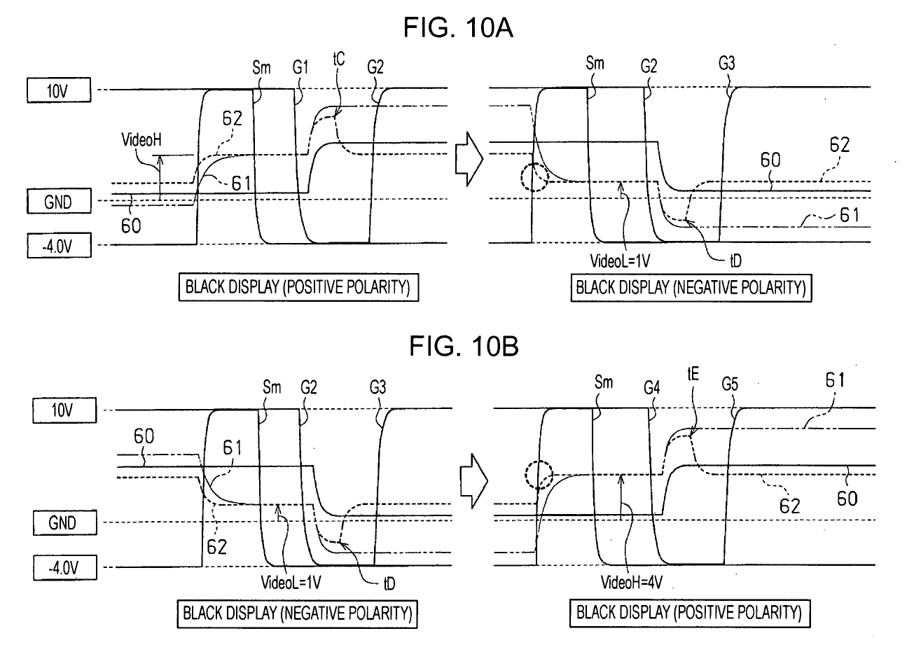

In contrast, in the liquid crystal device 10 according to the fourth embodiment, as shown on the left side of FIG. 10A, if the potential of each data line is the highest at the point of time at which the video signal is written in the next horizontal scanning period, and the potential of each of the data lines X1 to Xm exceeds the power supply VDH, the forward diodes 54 and 56 become the ON state. Accordingly, the drain current flows in the forward diodes 54 and 56, the potential of each of the data lines X1 to Xm falls from the point of time tC of FIG. 10A and is close to the voltage of the power supply VDH (returns up to the potential before the change), and then the forward diodes 54 and 56 become the OFF state. That is, the potential of each of the data lines X1 to Xm which rises up to 8 V returns to the level close to the power supply VDH. In this state, when the low-potential video signal (the negative-polarity video signal) is written, the level of the voltage to be written into each pixel 25 is made lower than 8V in case of the related art liquid crystal device described above, and thus the deficiency in writing of the video signal into each pixel is difficult to occur.

Further, in the liquid crystal device 10 according to the fourth embodiment, like the first embodiment described with reference to FIG. 6, if the potential of each data line is lowest, and the potential of each of the data lines X1 to Xm is made lower than the voltage of the power supply VDL, the reverse diodes 55 and 57 become the ON state. Accordingly, the drain current flows in the reverse diodes 55 and 57, the potential of each of the data lines X1 to Xm rises from the point of time tD of FIG. 10B and is close to the voltage of the power supply VDL (returns up to the potential before the change), and then the reverse diodes 55 and 57 become the OFF state. In this state, when the high-potential video signal is written, the level of the voltage to be written into each pixel 25 is made lower than 7 V in case of the related art liquid crystal device described above, and thus the deficiency in writing of the video signal into each pixel is difficult to occur.

Moreover, the point of time tE of FIG. 10B represents the same timing as the point of time tC of FIG. 10A.

According to the fourth embodiment having such a configuration, the following advantages are obtained, in addition to the advantages of the above-described first embodiment.

At the point of time at which the video signal is written in the next horizontal scanning period, even when the potential of each data line is highest or lowest, the potential of each data line can substantially have the same potential as that of the video signal, and thus the deficiency in writing of the video signal into each pixel can be suppressed from occurring.

Writing of the video signal into each pixel can be further helped by supplying a separate power supply, such as the power supply that has the level equal to or higher than the high-potential voltage value VideoH of the swing level of the video signal or the power supply that has the level equal to or lower than the low-potential voltage value VideoL of the swing level.

Electronic Apparatus

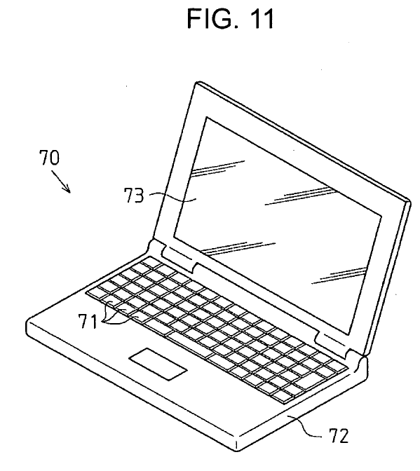

Next, an electronic apparatus, which uses the liquid crystal display panel 21 of the liquid crystal device 10 described in the individual embodiment described above, will be described. The liquid crystal device 10 can be applied to a mobile-type personal computer shown in FIG. 11. The personal computer 70 shown in FIG. 11 has a main body 72 having a keyboard 71, and a display unit 73 using the liquid crystal display panel 21.

According to the personal computer 70, high-quality display can be performed.

Moreover, the invention can be modified and specified as follows.

In the first embodiment, the liquid crystal device 10, which performs the common swing driving system for inverting the common potential VCOM for each horizontal scanning period, has been exemplified, but the invention can be applied to a liquid crystal device 10, which performs the common swing driving system for inverting the common potential VCOM for each frame period as the predetermined period. Here, the ‘one frame period’ means a period in which the scanning lines Y1 to Yn are sequentially selected, the video signals are written into the capacitors (liquid crystal capacitors 31 and the storage capacitors 32) of all the pixels, and display for one screen is performed.

In the first embodiment, the writing auxiliary circuits 81 and 82 are provided at both the input terminal and the output terminal of each of the data lines X1 and Xm, but the invention can be applied a configuration in which a writing auxiliary circuit is provided at one of the input terminal and the output terminal of each of the data lines X1 to Xm or is partially provided for the data lines X1 to Xm.

In the fourth embodiment shown in FIG. 9, the forward diodes 54 and 56 and the reverse diodes 55 and 57 can be constituted by the PIN diode 52 of the second embodiment shown in FIG. 7 or the MOS diode 53 using the four-terminal thin film transistor of the third embodiment shown in FIG. 8.

In the embodiment, the configuration in which the invention is specified as the liquid crystal device, which is an example of an electro-optical device, has been described, but the invention can be applied to various electro-optical devices, such as an organic light-emitting diode device, a fluorescent electro-optical device using discharge (for example, a plasma display), and the like.

In FIG. 11, as an example of the electronic apparatus having the liquid crystal device 10, the personal computer has been described, but the liquid crystal device 10 described in the embodiment is not limited to the personal computer, but can be applied to various electronic apparatuses, such as a cellular phone, a digital camera, and the like.

What is claimed is:

1. An electro-optical device comprising:
a plurality of first electrodes that are disposed to correspond to intersections of a plurality of scanning lines and a plurality of data lines;
a second electrode that is provided to face the first electrodes;
an electro-optical material that is interposed between the first electrodes and the second electrode; and
switching elements that control the potential of each of the first electrodes,
wherein the potential of the second electrode alternately changes, and a positive-polarity video signal and a negative-polarity video signal are alternately written into the individual first electrodes for each predetermined period via the electro-optical material, and
for the plurality of data lines, each of which supplies a video signal to each first electrode, a writing auxiliary circuit is partially provided so as to discharge electric charges accumulated in the data lines.

2. The electro-optical device according to claim 1,
wherein the writing auxiliary circuit is a discharging circuit that has either reverse diodes or forward diodes.

3. The electro-optical device according to claim 1,
wherein the writing auxiliary circuit is a discharging circuit that has both reverse diodes and forward diodes.

4. The electro-optical device according to claim 2,
wherein the reverse diodes and the forward diodes are MOS diodes.

5. The electro-optical device according to claim 2,
wherein the reverse diodes and the forward diodes are PIN diodes.

6. The electro-optical device according to claim 2,
wherein the reverse diodes and the forward diodes are MOS diodes, each of which uses a four-terminal thin film transistor.

7. The electro-optical device according to claim 3,
wherein a power supply connected to each of the forward diodes has a level equal to or higher than a high-potential voltage value of a swing level of the video signal, and a power supply connected to each of the reverse diodes has a level equal to or lower than a low-potential voltage value of the swing level of the video signal.

8. An electronic apparatus comprising the electro-optical device according to claim 1.
